(19) United States
(12) Patent Application Publication
(10) Pub. No.: US 2016/0049643 A1
(43) Pub. Date: Feb. 18, 2016

(54) CATHODE MATERIAL, CATHODE INCLUDING THE SAME, AND LITHIUM BATTERY INCLUDING THE CATHODE

(71) Applicant: SAMSUNG SDI CO., LTD., Yongin-si (KR)

(72) Inventors: In Kim, Yongin-si (KR); Eunjung Kim, Yongin-si (KR); Sangwoon Yang, Yongin-si (KR); Jongbum Lee, Yongin-si (KR); Youngeun Kim, Yongin-si (KR); Jaekyung Kim, Yongin-si (KR)

(21) Appl. No.: 14/821,626

(22) Filed: Aug. 7, 2015

(30) Foreign Application Priority Data
Aug. 13, 2014 (KR) 10-2014-0105324

(51) Int. Cl. H01M 4/36; H01M 10/0525; H01M 4/587; H01M 4/62; H01M 4/525; H01M 4/505; H01M 4/485; H01M 4/133; H01M 4/131

(52) U.S. Cl. CPC H01M 4/364; H01M 4/133; H01M 10/0525; H01M 4/587; H01M 4/131; H01M 4/525; H01M 4/505; H01M 4/485; H01M 4/625; H01M 4/623; H01M 2004/027

(57) ABSTRACT

A cathode material includes a cathode active material; and a carbon material of secondary particles including a plurality of primary particles, where the carbon material of the secondary particles has an average chain length that is equal to or less than 50 primary particles coupled to each other. A cathode includes the cathode material and a current collector. A lithium battery includes the cathode.

### CROSS-REFERENCE TO RELATED APPLICATION

This application claims priority to and the benefit of Korean Patent Application No. 10-2014-0105324, filed on Aug. 13, 2014, in the Korean Intellectual Property Office, the entire content of which is incorporated herein by reference.

### BACKGROUND

1. Field

One or more example embodiments relate to a cathode material, a cathode including the cathode material, and a lithium battery including the cathode.

2. Description of the Related Art

Demand for secondary batteries used in mobile electronic devices for information and communication, including personal digital assistants, cell phones, and laptop computers, and in electric bicycles or electric cars is rapidly increasing. Lithium batteries, for example, lithium ion batteries (LIBs) have high energy density and are easy to be designed, and thus, are used as a power source for electric vehicles or electrical power storage in addition to being used in portable information technology (IT) devices. The lithium ion batteries should have high energy densities and/or long lifespan characteristics.

Studies on a cathode material have been conducted in order to manufacture lithium ion batteries having suitable characteristics. However, for example, microcracking may occur in a cathode active material due to decreased contact between the cathode active material and a current collector, oxidization of a conducting material, stress caused by repeated charging/discharging of the battery and/or a roll-press process used during a cathode manufacturing process, and thus, the capacity of the battery may decrease and the resistance of the battery may increase.

### SUMMARY

One or more aspects of example embodiments include a cathode material having high energy density and/or long lifespan characteristics by increasing battery capacity and reducing resistance.

One or more aspects of example embodiments include a cathode including the cathode material.

One or more aspects of example embodiments include a lithium battery including the cathode.

Additional aspects will be set forth in part in the description which follows and, in part, will be apparent from the description, or may be learned by practice of the presented embodiments.

According to one or more example embodiments, a cathode material includes a cathode active material; and a carbon material of secondary particles including (e.g., consisting of) a plurality of primary particles, the carbon material of the secondary particles having an average chain length that is equal to or less than 50 primary particles coupled (or connected) to each other.

According to one or more example embodiments, a cathode includes the cathode material and a current collector.

According to one or more example embodiments, a lithium battery includes a cathode including the cathode material; an anode including an anode active material; and an electrolyte between the cathode and the anode.

### BRIEF DESCRIPTION OF THE DRAWINGS

These and/or other aspects will become apparent and more readily appreciated from the following description of the example embodiments, taken in conjunction with the accompanying drawings in which:

FIG. 1A is a schematic view of a cathode material according to an embodiment;

FIG. 1B is a schematic view of a cathode material prepared according to Comparative Example 1;

FIGS. 2A and 2B are images of cathode materials on surfaces of cathodes prepared according to Example 1 and Comparative Example 1, respectively, taken using a transmission electron microscope (HR-TEM) up to a resolution of several tens of nanometers (nm);

FIGS. 2C and 2D are images of the cathode materials on the surfaces of the cathodes prepared according to Example 1 and Comparative Example 1, respectively, taken using a transmission electron microscope (HR-TEM) up to a resolution of several nm;

FIGS. 3A and 3B are images of the cathode materials on the surfaces of the cathodes prepared according to Example 1 and Comparative Example 1, respectively, taken using a scanning electron microscope (SEM) up to a resolution of several hundreds of nm;

FIG. 4 is a graph showing a viscosity change with respect to a shear rate with respect to the cathode materials on the surfaces of the respective cathodes prepared according to Example 1 and Comparative Example 1;

FIG. 5 is an exploded perspective view of a lithium battery according to an embodiment;

FIG. 6 is a perspective view schematically illustrating a battery pack according to an embodiment;

FIG. 7 is a graph showing resistances of respective lithium batteries prepared according to Example 3 and Comparative Example 3 in SOC 20%, SOC 50%, and SOC 90%, separately;

FIG. 8 is a graph showing lifespan characteristics of the lithium batteries prepared according to Example 3 and Comparative Example 3;

FIG. 9 is a graph showing lifespan characteristics of the lithium batteries prepared according to Example 3 and Comparative Example 3 kept after 60 days; and

FIG. 10 is a graph showing lifespan characteristics of lithium batteries prepared according to Example 4 and Comparative Example 4 measured using a reference performance test with respect to a 18560 cell.

### DETAILED DESCRIPTION

Reference will now be made in more detail to example embodiments of a cathode material, a cathode including the cathode material, and a lithium battery including the cathode, examples of which are illustrated in the accompanying drawings, wherein like reference numerals refer to like elements throughout. In this regard, the present example embodiments may have different forms and should not be construed as being limited to the descriptions set forth herein. Accordingly, the example embodiments are merely described below, by referring to the drawings, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. Also, in the context of the present application, when a first element is referred to as being “on” a second element, it can be directly on the second element or be indirectly on the second element with one or more intervening elements interposed therebetween. As used herein, the term “substantially,” “about,” and similar terms are used as terms of approximation and not as terms of degree, and are intended to account for the inherent deviations in measured or calculated values that would be recognized by those of ordinary skill in the art. Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. §112(a), and 35 U.S.C. §132(a).

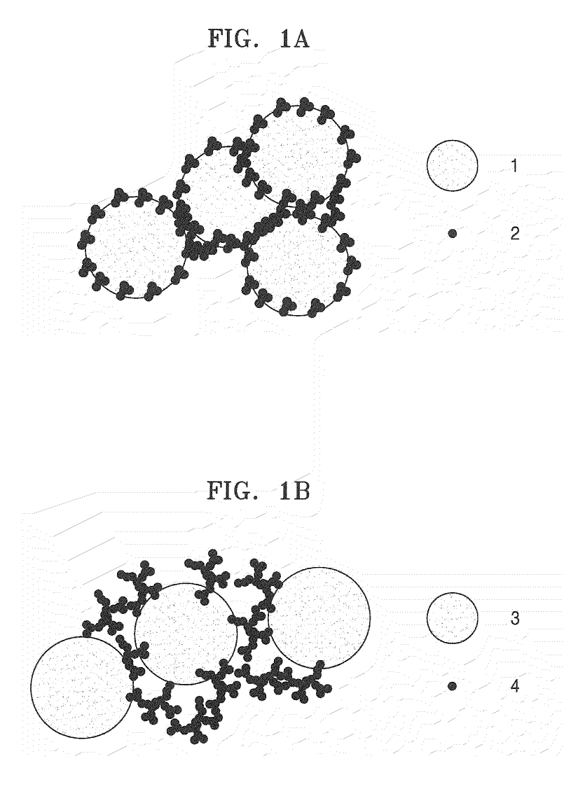

FIG. 1A is a schematic view of a cathode material according to an embodiment. FIG. 1B is a schematic view of a cathode material prepared according to Comparative Example 1.

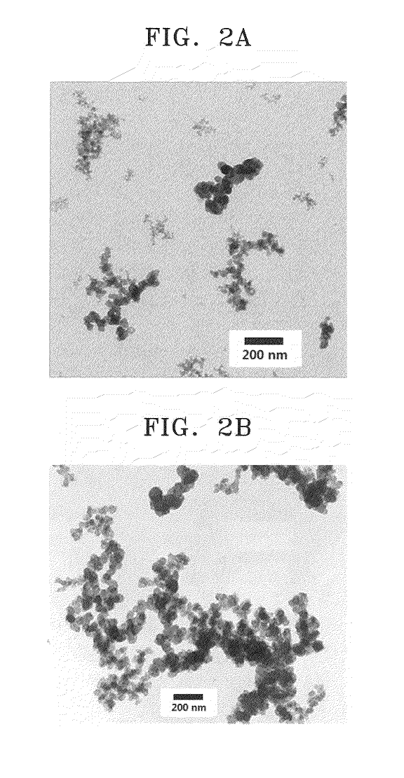

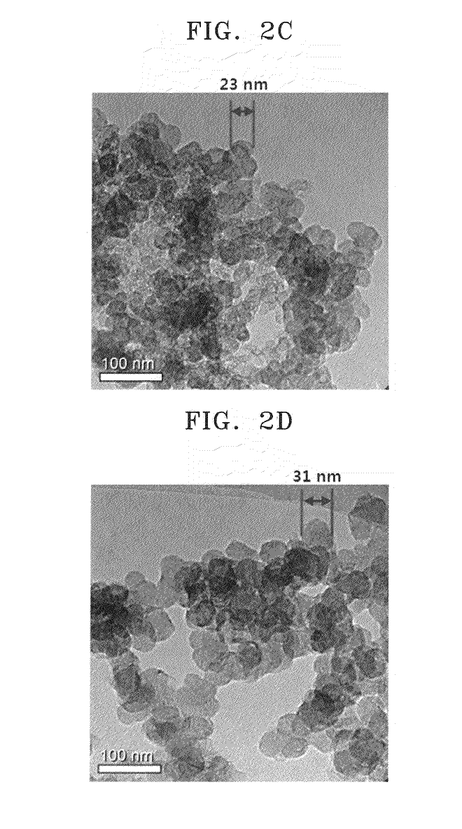

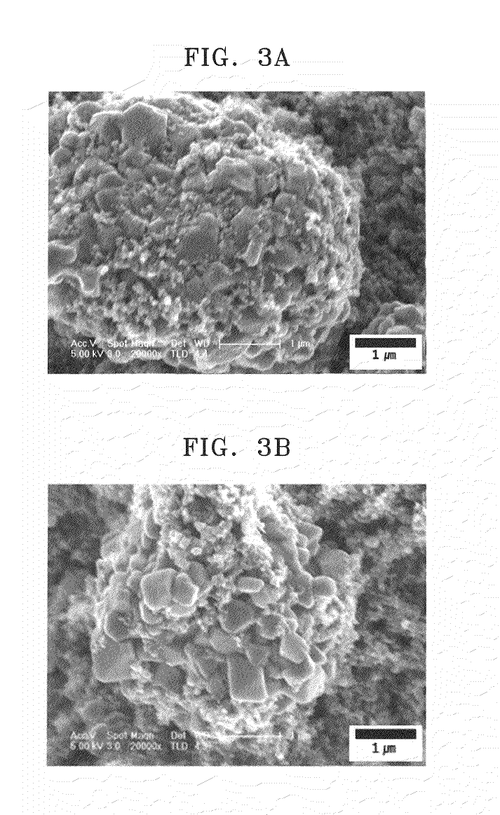

Referring to FIG. 1A, according to an embodiment, the cathode material includes a cathode active material 1; and a carbon material 2 of secondary particles including (or consisting of) a plurality of primary particles, wherein the carbon material 2 of the secondary particles have an average chain length that is equal to or less than 50 primary particles coupled (or connected) to each other. For example, the carbon material 2 of the secondary particles may have an average chain length that is equal to or less than 30 primary particles coupled (or connected) to each other. For example, the carbon material 2 of the secondary particles may have an average chain length that is equal to or less than 20 primary particles coupled (or connected) to each other. For example, the carbon material 2 of the secondary particles may have an average chain length that is equal to or less than 15 primary particles coupled (or connected) to each other. For example, the carbon material 2 of the secondary particles may have an average chain length with the range of about 2 to about 15 primary particles coupled (or connected) to each other. The average chain length of the carbon materials 2 of the secondary particles can be measured by transmission electron microscope (TEM) and scanning electron microscope (SEM) images in FIGS. 2a to 2d, 3a, and 3d.

The carbon material 2 of secondary particles may generally have an average chain length that is, for example, shorter than an average chain length of a carbon material included in other cathode materials, for example, as shown in FIG. 1B. For example, as can be seen in FIG. 1B, the cathode material prepared according to Comparative Example 1 includes a cathode active material 3; and a carbon material 4 of secondary particles having an average chain length longer than 50 primary particles coupled (or connected) to each other. In this regard, relative to a cathode material including a carbon material of secondary particles having an average chain length longer than 50 primary particles coupled (or connected) to each other, a dispersion degree of the cathode active material 1 and the carbon material 2 included in the cathode material may increase, respective distances of pathways of electrons may be reduced, and thus, an electronic conductivity (electrical conductivity) of the cathode material may increase. In addition, the energy density and/or lifespan characteristics of the cathode material may improve.

An average particle diameter of the primary particles may be in a range of about 5 nm to about 30 nm. For example, an average particle diameter of the primary particles may be in a range of about 10 nm to about 28 nm. For example, an average particle diameter of the primary particles may be in a range of about 18 nm to about 28 nm. The average particle diameter of the primary particles can be also measured by transmission electron microscope (TEM) and scanning electron microscope (SEM) images in FIGS. 2a to 2d, 3a, and 3d.

A specific surface area of the carbon material 2 may be in a range of about 100 m²/g to about 300 m²/g. For example, a specific surface area of the carbon material 2 may be in a range of about 100 m²/g to about 200 m²/g. For example, the specific surface area of the carbon material 2 may be in a range of about 120 m²/g to about 200 m²/g. The specific surface area of the carbon material 2 can be measured by Brunauer Emmett Teller (BET) analysis.

When the primary particles have an average particle diameter within the ranges above, a dispersion degree of the cathode active material 1 and the carbon material 2 included in the cathode material may further increase, a specific surface area of the primary particles may increase, and thus, the electronic conductivity (electrical conductivity) of the cathode material including the primary particles may further increase. Also, the energy density and/or lifespan characteristics of the cathode material may further improve.

An oil absorption number (OAN) of the carbon material may be in a range of about 100 ml/100 g to about 200 ml/100 g. For example, the oil absorption number of the carbon material 2 may be in a range of about 100 ml/100 g to about 180 ml/100 g. For example, the oil absorption number of the carbon material 2 may be in a range of about 120 ml/100 g to about 180 ml/100 g. The oil absorption number (OAN) of the carbon material can be obtained by using ASTM D2414 test method. When the cathode material including the carbon material 2 is used, the dispersion of the cathode material may increase during a cathode material mixing process which may result in a decrease in the amount of an organic solvent thus used, and thus, a cost of manufacturing a battery including the cathode material may decrease. Also, the amount of solid powder of the cathode material may increase due to the decrease in the amount of the organic solvent, and thus, a cathode material having a stable or suitable viscosity may be manufactured.

The amount of the carbon material 2 may be in a range of about 1 wt % to about 15 wt % based on the total weight of the cathode material. For example, the amount of the carbon material 2 may be in a range of about 1 wt % to about 13 wt % based on the total weight of the cathode material. For example, the amount of the carbon material 2 may be in a range of about 1 wt % to about 10 wt % based on the total weight of the cathode material. When the amount of the carbon material 2 in the cathode material is within the ranges above, the electronic conductivity (electrical conductivity) and packing density of the cathode material may improve.

The carbon material 2 may include at least one selected from carbon black (e.g., acetylene black and/or Denka Black) and an aerogel.

The cathode material may further include at least one additive selected from natural graphite, artificial graphite, carbon black (e.g., acetylene black, and/or ketjen black), carbon fibers, metal powder, and metal fibers.

The amount of the additive may be in a range of about 0.1 wt % to about 15 wt % based on the total weight of the cathode material. For example, the amount of the additive may be in a range of about 0.1 wt % to about 10 wt %. In some embodiments, the amount of the additive is in a range of about 0.1 wt % to about 5 wt %. In other embodiments, the amount of the additive is in a range of about 0.1 wt % to about 3 wt %. When the amount of the additive included in the cathode material is within the ranges above, a battery including the cathode material may have an increased capacity and a decreased resistance, and thus, a lithium battery provided by using the cathode material may have an improved high energy density and/or long lifespan characteristics.

The cathode material may further include a binder. Examples of the binder may include polyvinylalcohol, carboxymethylcellulose, hydroxypropylcellulose, diacetylcellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, or a combination thereof, but the binder is not limited thereto.

The amount of the binder may be in a range of about 0.1 wt % to about 15 wt % based on the total weight of the cathode material. For example, the amount of the binder may be in a range of about 0.1 wt % to about 10 wt %. In some embodiments, the amount of the binder is in a range of about 0.1 wt % to about 5 wt %. In other embodiments, the amount of the binder may be in a range of about 0.1 wt % to about 3 wt %. When the amount of the binder is within these ranges, a bonding strength between the cathode material and the cathode current collector may further increase.

The cathode active material 1 may be a compound capable of reversibly intercalating/deintercalating lithium ions. Examples of the cathode active material 1 may include at least one selected from a lithium nickel oxide, a lithium cobalt oxide, a lithium cobalt aluminum oxide, a lithium nickel cobalt manganese oxide, a lithium manganese oxide, a lithium nickel oxide doped with at least one selected from chrome (chromium), zirconium, and titanium, a lithium cobalt oxide doped with at least one selected from chrome (chromium), zirconium, and titanium, a lithium cobalt aluminum oxide doped with at least one selected from chrome (chromium), zirconium, and titanium, a lithium nickel cobalt manganese oxide doped with at least one selected from chrome (chromium), zirconium, and titanium, a lithium manganese oxide doped with at least one selected from chrome (chromium), zirconium, and titanium, and an olivine-based oxide. For example, the cathode active material 1 may include LiMn₂O₄, LiNi₂O₄, LiCoO₂, LiNiO₂, LiMnO₂, Li₂MnO₃, LiFePO₄, LiNiₓCo_{y}O₂ (where 0<x≦0.15 and 0<y≦0.85), LiₐNi_{b}Co_{c}Mn_{d}GₑO₂ (where, 0.90≦a≦1.8, 0≦b≦0.9, 0≦c≦0.5, 0≦d≦0.5, and 0.001≦e≦0.1), Li_{(3-f)}J₂(PO₄)₃ (where 0≦f≦2), or Li_{3-f}Fe₂(PO₄)₃ (where 0≦f≦2). In the foregoing formulae, G is Al, Cr, Zr, Ti, or a combination thereof, and J is V, Cr, Mn, Co, Ni, Cu, or a combination thereof. However, cathode active material is not limited thereto, and any suitable material available in the art as a cathode active material may be used.

According to another embodiment, a cathode includes the cathode material and a current collector (e.g., the cathode material may be on the current collector). Examples of the current collector may include aluminum, stainless steel, nickel, titanium, platinum, or a combination thereof.

The amount of solid of the cathode material may be about 65 wt % or greater based on the total weight of the cathode. For example, the amount of solid of the cathode material may be about 66 wt % or greater based on the total weight of the cathode. For example, the amount of solid of the cathode material may be about 67 wt % or greater based on the total weight of the cathode.

A bonding strength between the cathode material and the current collector may be 1.5 gf/mm (gram-force/mm) or greater. For example, a bonding strength between the cathode material and the current collector may be 1.6 gf/mm (gram-force/mm) or greater. For example, a bonding strength between the cathode material and the current collector may be 1.7 gf/mm (gram-force/mm) or greater.

A specific resistance of the cathode may be about 12 milliohms (mΩ) or lower. For example, a specific resistance of the cathode may be about 11 milliohms (mΩ) or lower. For example, a specific resistance of the cathode may be about 10 milliohms (mΩ) or lower.

According to another embodiment, a lithium battery includes a cathode including the cathode material as described above; an anode including an anode active material, and an electrolyte between the cathode and the anode.

The cathode material may be, for example, a cathode material of a paste type (a paste kind), a slurry type (a slurry kind), or a dispersion solution. According to embodiments of the present disclosure, the cathode material may be, for example, prepared as follows.

The cathode material and a solvent are mixed to prepare a cathode active material slurry, and the slurry is coated (e.g., directly coated) on an aluminum current collector to prepare the cathode. In some embodiments, the cathode active material slurry may be cast on a separate support, and a cathode active material film separated from the support may be laminated on an aluminum current collector to prepare the cathode. The solvent may be an organic solvent, for example, N-methylpyrrolidone (NMP) or acetone.

Next, an anode may be prepared. The anode may be prepared in the same or substantially the same manner as the cathode, except that an anode active material is used instead of the cathode active material.

For example, the anode may be prepared as follows.

The anode active material, a conducting material (a conductive material), and, optionally, a binder, and a solvent are mixed to prepare an anode active material slurry, and the slurry may be directly coated on a copper current collector to prepare the anode. In some embodiments, the anode active material slurry may be cast on a separate support, and an anode active material film separated from the support may be laminated on a copper current collector to prepare the anode.

The anode active material may include at least one selected from a material capable of reversibly intercalating and deintercalating lithium ions, a lithium metal, or a metal material alloyable with lithium.

Examples of the material capable of reversibly intercalating and deintercalating lithium ions may be a carbon-based material which may be any suitable carbon-based anode active material that is generally used in a lithium battery, and an example of the carbon-based material may be crystalline carbon, amorphous carbon, or a mixture thereof.

Examples of the crystalline carbon include graphite, such as amorphous, plate-shaped, flake-shaped, sphere (spherical), or fibrous natural graphite or artificial graphite, and examples of the amorphous carbon include soft carbon (carbon that has been heat treated at a relatively low temperature) or hard carbon, mesophase pitch carbide, and calcinated cokes.

Examples of the anode active material may include at least one selected from vanadium oxide, lithium vanadium oxide, Si, SiOₓ (0<x<2), a Si—Y alloy (Y is an alkali metal, an alkali earth metal, an element of Group 13 to Group 16, a transition metal, a rare earth element, or a combination thereof, and is not Si), Sn, SnO₂, and a Sn—Y alloy (Y is an alkali metal, an alkali earth metal, an element of Group 13 to Group 16, a transition metal, a rare earth element, or a combination thereof, and is not Sn), or a mixture of at least one selected therefrom and SiO₂. Examples of Y include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

In the anode active material slurry, a conducting material (a conductive material), a binder, and a solvent may be the same or substantially the same as those used in the preparation of the cathode. For example, the conducting material may be the same or substantially the same as the additive described with respect to the cathode material. In some embodiments, a plasticizer may be added independently to each of the cathode active material slurry and the anode active material slurry to form pores in an electrode plate.

Amounts of the anode active material, the conducting material (the conductive material), the binder, and the solvent may be the same or substantially the same as generally used in lithium batteries. At least one of the conducting material (the conductive material), the binder, and the solvent may be omitted if desired depending on the use and the structure of the lithium battery.

Next, in some embodiments, the separator to be disposed between the cathode and the anode is prepared. The separator may be any suitable separator available in the art that is generally used in a lithium battery. A separator having low resistance to ion movement of an electrolyte and high electrolyte uptake may be used. For example, in some embodiments, the separator is selected from glass fibers, polyester, Teflon, polyethylene, polypropylene, polytetrafluoroethylene (PTFE), and a combination thereof, each of which may be provided in the form of a non-woven fabric or a woven fabric. For example, a windable separator, such as polyethylene or polypropylene, may be used in a lithium ion battery, and a separator having high organic electrolyte uptake may be used in a lithium ion polymer battery. For example, according to some embodiments, the separator may be prepared as follows.

A separator composition is prepared by mixing a polymer resin, a filler, and a solvent. The separator composition may be coated (directly coated) and dried on an electrode to complete the formation of the separator. In some embodiments, the separator composition may be cast on a separate support and then a film separated from the support is laminated on an electrode, thereby completing the formation of the separator.

The polymer resin used in preparing the separator may not be particularly limited, and any suitable materials used for a binder of an electrode plate may be used. For example, a vinylidene fluoride/hexafluoropropylene copolymer, polyvinylidenefluoride (PVDF), polyacrylonitrile, polymethylmethacrylate, or a mixture thereof may be used.

Then, in some embodiments, an electrolyte is prepared.

For example, the electrolyte may be a solid. For example, boron oxide, lithiumoxynitride, or the like may be used, but the electrolyte is not limited thereto, and the electrolyte may be any one of various suitable materials generally available in the art as a solid electrolyte. The solid electrolyte may be formed on an anode by, for example, sputtering.

For example, an organic electrolytic solution may be prepared. The organic electrolytic solution may be prepared by dissolving a lithium salt in an organic solvent.

The organic solvent may be any one of various suitable materials available in the art as an organic solvent. For example, the organic solvent may be propylene carbonate, ethylene carbonate, fluoro ethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethylsulfoxide, dioxane, 1,2-dimethoxyethane, sulfolane, dichloroethane, chlorobenzene, nitrobenzene, diethyleneglycol, dimethylether, or a mixture thereof.

The lithium salt may be any one of various suitable lithium salts used in the art. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where, x and y are natural numbers), LiCl, LiI, or a mixture thereof.

FIG. 5 is an exploded perspective view of a lithium battery 100.

The lithium battery 100 includes a cathode 114, a separator 113, and an anode 112. The cathode 114, the separator 113, and the anode 112 are wound or folded to be placed in a battery case 120. Then, an organic electrolytic solution is injected to the battery case 120, and the battery case 120 is sealed with a cap assembly 140 to complete the manufacturing of the lithium battery 100. The battery case 120 may be a cylindrical type (a cylindrical kind), a rectangular type (a rectangular kind), or a thin-film type (or a thin-film kind). For example, the lithium battery 100 may be a large thin film-type battery (a large thin film-kind of battery). The lithium battery 100 may be a lithium ion battery or may include battery assemblies. The battery assemblies may be stacked in a bi-cell structure, and the resultant structure may be immersed in an organic electrolytic solution, and the obtained result is housed in a pouch, followed by being sealed to complete the manufacturing of a lithium ion polymer battery.

The lithium battery 100 may be used at a current density in a range of, for example, about 2 mA/cm² to about 8 mA/cm² (e.g., the lithium battery may be configured to be operated at a current density of about 2 mA/cm² to about 8 mA/cm²). The lithium battery 100 may be used in an electric vehicle (EV) or a plug-in hybrid electric vehicle (PHEV) (e.g., the lithium battery is configured to power an EV or a PHEV).

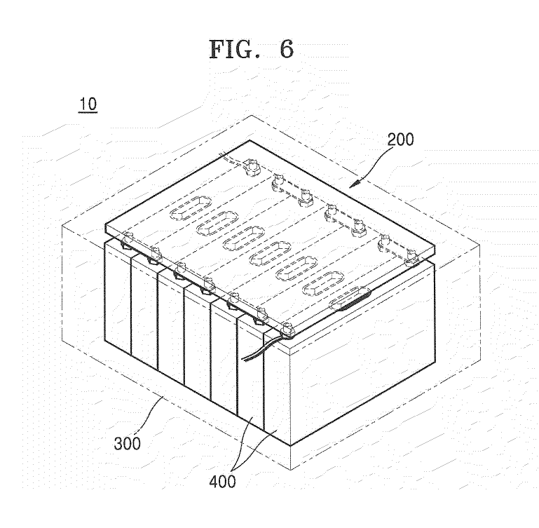

Also, in some embodiments, a plurality of the battery assemblies may be stacked and form a battery pack. FIG. 6 is a perspective view schematically illustrating a battery pack 10. As shown in FIG. 6, the battery pack 10 includes a plurality of battery assemblies 400, a cooling member 200, and a housing 300. The plurality of battery assemblies 400 are arranged in rows, side-by-side. A battery cell 100 may be accommodated in the housing 300.

Hereinafter, one or more embodiments will be described with reference to the following examples. However, these examples are not intended to limit the scope of the one or more embodiments.

Also, details associated with one or more embodiments that should be readily appreciated by those of ordinary skill in the art are not repeated here.

### EXAMPLE

### (Preparation of Cathode)

### Example 1

### Preparation of Cathode

92 wt % of a cathode active material (LiNi_{0.33}Co_{0.33}Mn_{0.33}O₂), 3 wt % of a carbon material of secondary particles each having about 20 primary particles coupled (or connected) to each other, where an average particle diameter of the primary particles is about 23 nm, 1 wt % of graphite of flakes (available of Timcal), and 4 wt % of polyvinylidene fluoride (PVdF, Solef® 6020) were dispersed in N-methylpyrrolidone (NMP) to prepare a cathode active material slurry, the wt % being based on the total weight of the cathode active material slurry. Here, a specific surface area of the carbon material was about 150 m²/g, and an oil absorption number (OAN) of the carbon material was about 160 ml/100 g.

The cathode active material slurry was coated on an aluminum (Al) foil having a thickness of about 12 μm by bar coating. Here, the thickness of the Al foil coated with the cathode active material slurry thereon was about 183 μm.

The resultant Al foil coated with the cathode active material slurry thereon was put into an oven at 90° C. for a primary drying for about 2 hours to evaporate NMP and put into a vacuum oven at 120° C. for a secondary drying for about 2 hours to completely or substantially completely evaporate NMP. The resultant was roll-pressed and punched to prepare a cathode having a thickness of about 140 μm. Here, the capacity of the cathode was in a range of about 2.47 mAh/cm² to about 2.88 mAh/cm², a mixture density of the cathode was about 3.193 g/cc, and the amount of solid of the cathode material was about 68.63 wt % based on the total weight of the cathode.

### Example 2

### Preparation of Cathode

92 wt % of a cathode active material (prepared by mixing LiNi_{0.33}Co_{0.33}Mn_{0.33}O₂ and LiMnO₂ at a weight ratio of 50:50), 4 wt % of a carbon material of secondary particles each having about 20 primary particles coupled (or connected) to each other, where an average particle diameter of the primary particles is about 23 nm, and 4 wt % of polyvinylidene fluoride (PVdF, Solef® 6020) were dispersed in NMP to prepare a cathode active material slurry, the wt % being based on the total weight of the cathode active material slurry. Here, a specific surface area of the carbon material was about 150 m²/g, and an oil absorption number of the carbon material was about 160 ml/100 g.

The cathode active material slurry was coated on an Al foil having a thickness of about 12 μm by bar coating. Here, the thickness of the Al foil coated with the cathode active material slurry thereon was about 180 μm.

The resultant Al foil coated with the cathode active material slurry thereon was put into an oven at 90° C. for a primary drying for about 2 hours to evaporate NMP and put into a vacuum oven at 120° C. for a secondary drying for about 2 hours to completely or substantially completely evaporate NMP. The resultant was roll-pressed and punched to prepare a cathode having a thickness of about 133 μm. Here, the capacity of the cathode was about 175 mAh/cm², and a loading level of the cathode was about 32.74 mg/cm².

### Comparative Example 1

### Preparation of Cathode

92 wt % of a cathode active material (LiNi_{0.33}Co_{0.33}Mn_{0.33}O₂), 3 wt % of a carbon material of secondary particles each having about 50 primary particles coupled (or connected) to each other, where an average particle diameter of the primary particles is about 31 nm, 1 wt % of graphite of flakes (available of Timcal), and 4 wt % of polyvinylidene fluoride (PVdF, Solef® 6020) were dispersed in NMP to prepare a cathode active material slurry, the wt % being based on the total weight of the cathode active material slurry. Here, a specific surface area of the carbon material was in a range of about 50 m²/g to about 70 m²/g, and an oil absorption number of the carbon material was in a range of about 220 ml/100 g to about 300 ml/100 g.

The cathode active material slurry was coated on an Al foil having a thickness of about 12 μm by bar coating. Here, the thickness of the Al foil coated with the cathode active material slurry thereon was about 170 μm.

The resultant Al foil coated with the cathode active material slurry thereon was put into an oven at 90° C. for a primary drying for about 2 hours to evaporate NMP and in a vacuum oven at 120° C. for a secondary drying for about 2 hours to completely or substantially completely evaporate NMP. The resultant was roll-pressed and punched to prepare a cathode having a thickness of about 128 μm. Here, the capacity of the cathode was in a range of about 2.47 mAh/cm² to about 2.88 mAh/cm², a mixture density of the cathode was about 3.2 g/cc, and the amount of solid of the cathode material was about 63.73 wt % based on the total weight of the cathode.

### Comparative Example 2

### Preparation of Cathode

92 wt % of a cathode active material (prepared by mixing LiNi_{0.33}Co_{0.33}Mn_{0.33}O₂ and LiMnO₂ at a weight ratio of 50:50), 4 wt % of a carbon material of secondary particles each having about 50 primary particles coupled (or connected) to each other, where an average particle diameter of the primary particles is about 31 nm, and 4 wt % of polyvinylidene fluoride (PVdF, Solef® 6020) were dispersed in NMP to prepare a cathode active material slurry, the wt % being based on the total weight of the cathode active material slurry. Here, a specific surface area of the carbon material was in a range of about 50 m²/g to about 70 m²/g, and an oil absorption number of the carbon material was in a range of about 220 ml/100 g to about 300 ml/100 g.

The cathode active material slurry was coated on an Al foil having a thickness of about 12 μm by bar coating. Here, the thickness of the Al foil coated with the cathode active material slurry thereon was about 189 μm.

The resultant Al foil coated with the cathode active material slurry thereon was put into an oven at 90° C. for a primary drying for about 2 hours to evaporate NMP and put into a vacuum oven at 120° C. for a secondary drying for about 2 hours to completely or substantially completely evaporate NMP. The resultant was roll-pressed and punched to prepare a cathode having a thickness of about 133 μm. Here, the capacity of the cathode was about 175 mAh/cm², and a loading level of the cathode was about 32.74 mg/cm².

### (Manufacture of Lithium Battery)

### Example 3

### Manufacture of Lithium Battery

### (Preparation of Anode)

97.5 wt % of graphite (available from Mitsubishi Chemical), and 2.5 wt % of a carboxymethylcellulose (CMC)/styrene-butadiene rubber (SBR) solution were added and mixed in an agate mortar to prepare an anode active material slurry. The anode active material slurry was coated on a copper foil having a thickness of 8 μm by bar coating. The resultant copper foil having the anode active material slurry coated thereon was put into an oven at 25° C., dried for about 10 hours, and then roll-pressed and punched to prepare an anode having a thickness of 133 μm.

(Preparation of Electrolyte)

An electrolyte was prepared by dissolving 1.15 M of LiPF₆ lithium salt in a mixture solvent including ethylene carbonate, diethyl carbonate, and ethylmethyl carbonate (at a volume ratio of EC/DEC/EMC=1:1:1).

(Manufacture of Lithium Battery)

The cathode prepared according to Example 1, the anode, the electrolyte, and a polyethylene separator (Celgard 2320) were used to prepare a 90 Ah cell.

### Example 4

### Manufacture of Lithium Battery

(Preparation of Anode)

97.5 wt % of graphite (available from Mitsubishi Chemical) and 2.5 wt % of a carboxymethylcellulose (CMC)/styrene-butadiene rubber (SBR) solution were added and mixed in an agate mortar to prepare an anode active material slurry. The anode active material slurry was coated on a copper foil having a thickness of 8 μm by bar coating. The resultant copper foil having the anode active material slurry coated thereon was put into an oven at 25° C., dried for about 10 hours, and then roll-pressed and punched to prepare an anode having a thickness of 102 μm.

(Preparation of Electrolyte)

An electrolyte was prepared by dissolving 1.15 M of LiPF₆ lithium salt in a mixture solvent including ethylene carbonate, diethyl carbonate, and ethylmethyl carbonate (at a volume ratio of EC/DEC/EMC=1:1:1).

(Manufacture of Lithium Battery)

The cathode prepared according to Example 2, the anode, the electrolyte, and a polyethylene separator (Celgard 2320) were used to prepare a 18650 cell.

### Comparative Example 3

### Manufacture of Lithium Battery

A 90 Ah cell was manufactured in the same manner as described with respect to Example 3, except that the anode prepared according to Comparative Example 1 was used instead of the anode prepared according to Example 1.

### Comparative Example 4

### Manufacture of Lithium Battery

A 18650 cell was manufactured in the same manner as described with respect to Example 4, except that the anode prepared according to Comparative Example 2 was used instead of the anode prepared according to Example 2.

### Analysis Example 1

### Transmission Electron Microscope (TEM) and Scanning Electron Microscope (SEM) Images

The cathode materials on surfaces of the respective cathodes prepared according to Example 1 and Comparative Example 1 were observed at a resolution in a range of several tens of nanometers (nm) to several nm using a transmission electron microscope (HR-TEM). The results are shown in FIGS. 2A to 2D.

Referring to FIGS. 2A to 2D, it was confirmed that an average particle diameter of the primary particles of the cathode material on a surface of the cathode prepared according to Example 1 was 23 nm, and an average particle diameter of the primary particles of the cathode material on a surface of the cathode prepared according to Comparative Example 1 was 31 nm. Thus, it was confirmed that the cathode material on a surface of the cathode prepared according to Example 1 had an average chain length that is equal to or less than 20 primary particles coupled (or connected) to each other, whereas the cathode material on a surface of the cathode prepared according to Comparative Example 1 had an average chain length that is equal to or more than 50 primary particles coupled (or connected) to each other.

Also, the cathode materials on surfaces of the respective cathodes prepared according to Example 1 and Comparative Example 1 were observed at a resolution of several hundreds of nm by using a scanning electron microscope (SEM, available from Hitachi, Model: S-5500). The results are shown in FIGS. 3A and 3B.

Referring to FIGS. 3A and 3B, the cathode material on a surface of the cathode prepared according to Example 1 was substantially evenly and homogeneously distributed on a cathode active material core, as compared to the cathode material on a surface of the cathode prepared according to Comparative Example 1.

### Analysis Example 2

### Viscosity Change Property

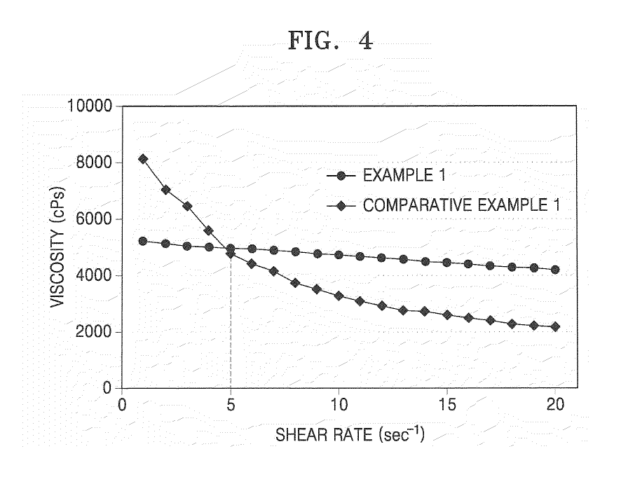

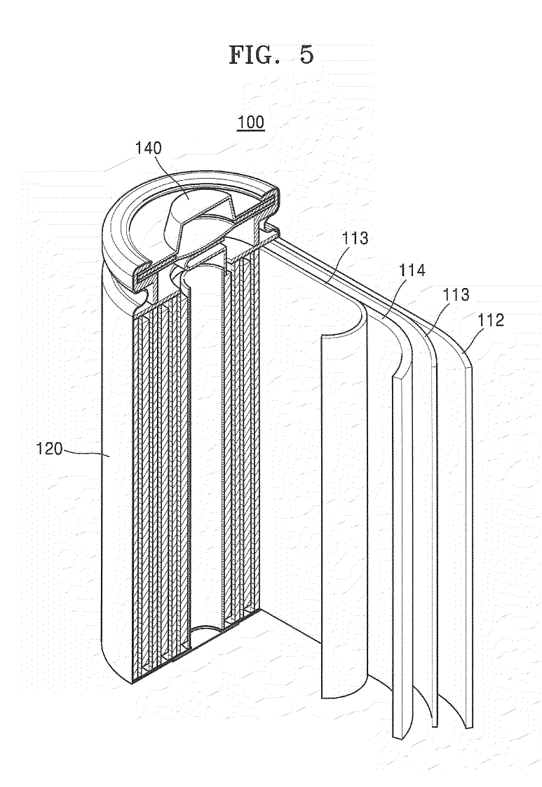

Viscosity change properties according to a shear rate with respect to the cathode materials on surfaces of the respective cathodes prepared according to Example 1 and Comparative Example 1 were analyzed. The results are shown in FIG. 4 and Table 1.

TABLE 1

| | Viscosity (cPs) | | |
|---|---|---|---|
| | @ a shear | @ a shear | @ a shear |
| | rate of | rate of | rate of |
| | 5/sec | 10/sec | 15/sec |
| Example 1 | 4971 | 4740 | 4464 |
| Comparative | 4798 | 3273 | 2608 |
| Example 1 | | | |

Referring to FIG. 4 and Table 1, it may be confirmed that a viscosity change according to a shear rate of the cathode material on a surface of the cathode prepared according to Example 1 showed highly stable movement, as compared to a viscosity change according to a shear rate of the cathode material on a surface of the cathode prepared according to Comparative Example 1. In this regard, it was determined that the carbon material on a cathode active material core included in the cathode material on a surface of the cathode prepared according to Example 1 may be dispersed in a relatively short period of time, as compared to that of the carbon material on a cathode active material core included in the cathode material on a surface of the cathode prepared according to Comparative Example 1, and thus, the cathode material prepared according to Example 1 may have stable viscosity.

### Evaluation Example 1

### Evaluation of Curvature

Curvatures of the respective cathodes prepared according to Example 1 and Comparative Example 1 were evaluated. The results are shown in Table 2. The curvatures were evaluated in lengths by cutting each of the electrode plates of the cathodes into a size of 145 mm×4 m, bending the electrode plate to form a curve to its maximum, and measuring a longest bending distance from a horizontal line to the electrode plate, where the horizontal line was a straight line formed by coupling (or connecting) two ends of the electrode plate (e.g., to each other).

TABLE 2

| | Curvature |
|---|---|
| | (mm) |
| Example 1 | 2.5 |
| Comparative | 8.0 |
| Example 1 | |

Referring to Table 2, it may be confirmed that a curvature of the cathode prepared according to Example 1 was about ⅓ or less than that of the cathode prepared according to Comparative Example 1. In this regard, it was determined that the cathode prepared according to Example 1 had a higher energy density, as compared to that of the cathode prepared according to Comparative Example 1.

### Evaluation Example 2

### Evaluation of Bonding Strength

Bonding strengths between a cathode material and a current collector with respect to the respective cathodes prepared according to Example 2 and Comparative Example 2 were evaluated. The results are shown in Table 3. The respective bonding strengths were evaluated by cutting the electrode plates of the cathodes into a size of 20 mm×100 mm, and measuring forces (gf/mm) that separate the cathode materials prepared according to Example 1 and Comparative Example 1 from the current collectors by performing a 180 degree peel test using a tensile strength tester available from Instron. The results are shown in Table 3.

TABLE 3

| | Bonding |
|---|---|
| | strength |
| | (gf/mm) |
| Example 2 | 2.0 |
| Comparative | 1.1 |
| Example 2 | |

Referring to Table 3, a bonding strength between the cathode material and the current collector of the cathode prepared according to Example 2 was about 1.5 gf/mm or higher, which was higher than a bonding strength between the cathode material and the current collector of the cathode prepared according to Comparative Example 2.

### Evaluation Example 3

### Evaluation of Internal Resistance

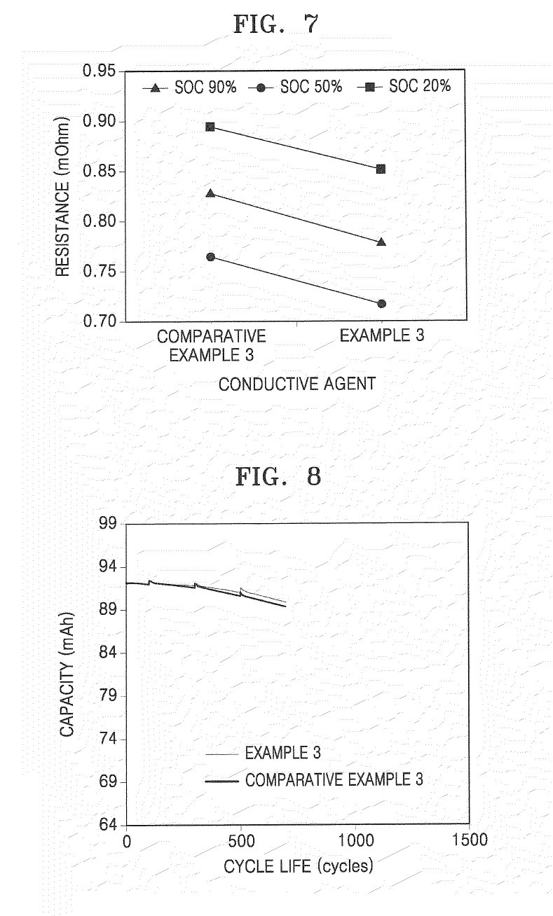

Internal resistances of the respective lithium batteries prepared according to Example 3 and Comparative Example 3 were measured at 25° C. The results are shown in FIG. 7 and Table 4. The internal resistances were measured by manufacturing five lithium batteries according to Example 3 and five lithium batteries according to Comparative Example 3, charging/discharging the lithium batteries for 10 seconds with a current of ⅓ C in SOC 20%, SOC 50%, and SOC 90%. Here, SOC 20%, SOC 50%, and SOC 90% respectively denote charge states of 20% charging capacity, 50% charging capacity, and 90% charging capacity of the batteries when the total charging capacity of the battery is 100%. The results are shown in FIG. 7 and Table 4.

TABLE 4

| | Internal resistance during discharging (mΩ) | | |
|---|---|---|---|
| | @SOC 20% | @SOC 50% | @SOC 90% |
| Example 3 | 0.87 | 0.75 | 0.75 |
| Comparative | 0.90 | 0.78 | 0.78 |
| Example 3 | | | |

Referring to FIG. 7 and Table 4, it may be confirmed that internal resistances during discharging of the lithium batteries of Example 3 were each reduced by about 3% to about 4% at SOC 20%, SOC 50%, and SOC 90%, as compared to the internal resistances during discharging of the lithium batteries of Comparative Example 3.

### Evaluation Example 4

### Evaluation of Lifespan Characteristics

4.1:Evaluation of Charging/Discharging Characteristics

Charging/discharging characteristics of respective lithium batteries prepared according to Example 3 and Comparative Example 3 were evaluated. Twice formation charging/discharging were performed on the respective lithium batteries prepared according to Example 3 and Comparative Example 3 (e.g., formation charging/discharging was performed two times), charged at a rate of 0.2 C until a voltage of the lithium batteries reached 4.12 V, and then the lithium batteries were discharged at a rate of 0.2 C until a voltage of the lithium batteries reached 2.7 V. Here, the charging/discharging conditions were standard charging/discharging conditions, and a discharge capacity used herein was a standard capacity.

Next, the lithium batteries were charged at a rate of 1 C in the same or substantially the same manner as described above and discharged at a rate of 1 C until a voltage of the lithium batteries reached 2.7 V. Here, a discharge capacity (a discharge capacity after the 1^{st} cycle) was measured. The charging/discharging process was repeated to evaluate lifespan characteristics of the lithium batteries. A discharge capacity after each cycle and a discharge capacity after 400^{th} cycle with respect to each of the lithium batteries were measured, and a capacity retention rate was calculated therefrom. The capacity retention rate (%) was defined as in Equation 1. The results are shown in FIG. 8 and Table 5.

Capacity retention rate (%)=discharge capacity after 400^{th} cycle/ discharge capacity after the 1^{st} cycle Equation 1

TABLE 5

| | Discharge capacity | Discharge capacity | Capacity |
|---|---|---|---|
| | after 1^{st} cycle | after 400^{th} cycle | retention |
| | (mAh) | (mAh) | rate (%) |
| Example 3 | 175 | 140 | 80 |
| Comparative | 172 | 120 | 70 |
| Example 3 | | | |

Referring to FIG. 8 and Table 5, it may be confirmed that a discharge capacity and a capacity retention rate of the lithium batteries prepared according to Example 3 were better than those of the lithium batteries prepared according to Comparative Example 3.

4.2: Evaluation of High Temperature Storage Characteristics

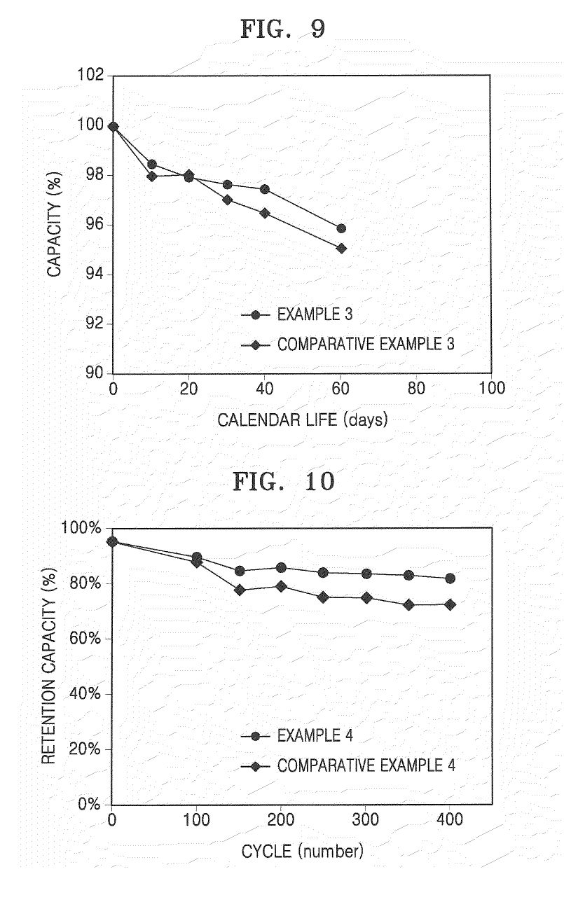

In the same or substantially the same manner as described with respect to 4.1, high temperature storage characteristics of the respective lithium batteries prepared according to Example 3 and Comparative Example 3 after 2 cycles of formation charging/discharging were evaluated. In order to evaluate the high temperature storage characteristics, the respective lithium batteries prepared according to Example 3 and Comparative Example 3 were charged in a room temperature chamber at a rate of 1 C until a voltage of the lithium batteries reached 4.12 V, and then discharged at a rate of 1 C until a voltage of the lithium batteries reached 2.7 V. Here, a discharge capacity (a discharge capacity after the 1^{st} cycle) was measured. The lithium batteries were left in a chamber at a temperature of 60° C. for 60 days. Then, a discharge capacity (a discharge capacity after 60 days) was measured, and a capacity retention rate was calculated therefrom. Here, the capacity retention rate (%) was defined as a % value obtained by dividing the discharge capacity after 60 days with the discharge capacity after the 1^{st} cycle. The results are shown in FIG. 9 and Table 6.

TABLE 6

| | Discharge capacity | Capacity |
|---|---|---|
| | after 1^{st} cycle | retention |
| | (Ah) | rate (%) |
| Example 3 | 88 | 96 |
| Comparative | 87 | 95 |
| Example 3 | | |

Referring to FIG. 9 and Table 6, it may be confirmed that a capacity retention rate of the lithium batteries prepared according to Example 3 was better than that of the lithium batteries prepared according to Comparative Example 3.

4.3: Evaluation of Lifespan Characteristics by Using Reference Performance Test

In the same or substantially the same manner as described with respect to 4.1, lifespan characteristics of the respective lithium batteries prepared according to Example 4 and Comparative Example 4 after twice formation charging/discharging were evaluated by using a reference performance test. In order to evaluate the lifespan characteristics, the respective lithium batteries prepared according to Example 4 and Comparative Example 4 were charged at a rate of 0.5 C until a voltage of the lithium batteries reached 4.12 V, and then discharged at a rate of 0.2 C until a voltage of the lithium batteries reached 2.7 V. Here, the charging/discharging conditions were standard charging/discharging conditions, and a discharge capacity used herein was a standard capacity.

Next, the lithium batteries were charged at a rate of 2 C in the same or substantially the same manner as described above and discharged at a rate of 3 C until a voltage of the lithium batteries reached 2.7 V. Here, a discharge capacity (a discharge capacity after the 1^{st} cycle) was measured. The charging/discharging process was repeated to evaluate lifespan characteristics of the lithium batteries. A discharge capacity after each cycle and a discharge capacity after the 400^{th} cycle with respect to each of the lithium batteries was measured, and a capacity retention rate was calculated therefrom. The capacity retention rate (%) was defined as in Equation 1. The results are shown in FIG. 10 and Table 7.

TABLE 7

| | Discharge capacity | Discharge capacity | Capacity |
|---|---|---|---|
| | after 1^{st} cycle | after 400^{th} cycle | retention |
| | (mAh) | (mAh) | rate (%) |
| Example 4 | 175 | 146 | 83 |
| Comparative | 172 | 128 | 74 |
| Example 4 | | | |

Referring to FIG. 10 and Table 8, it may be confirmed that a discharge capacity and a capacity retention rate of the lithium battery prepared according to Example 4 were better than those of the lithium battery prepared according to Comparative Example 4.

As described above, a cathode material according to the above embodiments may increase battery capacity and reduce resistance, and thus, may provide a cathode and a lithium battery having a high energy density and/or long lifespan characteristics. Also, the cathode material may reduce the amount of an organic solvent used in the preparation, and thus, may reduce a manufacturing cost of the cathode material. Therefore, a cathode material having high energy density and/or long lifespan characteristics (e.g., by increasing battery capacity and decreasing resistance), a cathode including the cathode material, and a lithium battery including the cathode may be prepared.

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the drawings, it will be understood by those of ordinary skill in the art that various changes in form and details may be made therein without departing from the spirit and scope as defined by the following claims, and equivalents thereof.

What is claimed is:

1. A cathode material comprising:
a cathode active material; and
a carbon material of secondary particles comprising a plurality of primary particles,
wherein the carbon material of the secondary particles has an average chain length less than 50 primary particles coupled to each other.

2. The cathode material of claim 1, wherein an average particle diameter of the primary particles is in a range of about 5 nm to about 30 nm.

3. The cathode material of claim 1, wherein a specific surface area of the carbon material is in a range of about 100 m²/g to about 300 m²/g.

4. The cathode material of claim 1, wherein an oil absorption number (OAN) of the carbon material is in a range of about 100 ml/100 g to about 200 ml/100 g.

5. The cathode material of claim 1, wherein the amount of the carbon material is in a range of about 1 wt % to about 15 wt % based on the total weight of the cathode material.

6. The cathode material of claim 1, wherein the carbon material comprises at least one selected from carbon black and an aerogel.

7. The cathode material of claim 1, wherein the cathode material further comprises at least one additive selected from natural graphite, artificial graphite, carbon black, carbon fibers, metal powder, and metal fibers.

8. The cathode material of claim 7, wherein the amount of the additive is in a range of about 0.1 wt % to about 15 wt % based on the total weight of the cathode material.

9. The cathode material of claim 1, wherein the cathode material further comprises a binder.

10. The cathode material of claim 9, wherein the amount of the binder is in a range of about 0.1 wt % to about 15 wt % based on the total weight of the cathode material.

11. The cathode material of claim 1, wherein the cathode active material is a compound capable of reversibly intercalating and deintercalating lithium ions.

12. The cathode material of claim 1, wherein the cathode active material comprises at least one selected from a lithium nickel oxide; a lithium cobalt oxide; a lithium cobalt aluminum oxide; a lithium nickel cobalt manganese oxide; a lithium manganese oxide; a lithium nickel oxide doped with at least one selected from chrome, zirconium, and titanium; a lithium cobalt oxide doped with at least one selected from chrome, zirconium, and titanium; a lithium cobalt aluminum oxide doped with at least one selected from chrome, zirconium, and titanium; a lithium nickel cobalt manganese oxide doped with at least one selected from chrome, zirconium, and titanium; a lithium manganese oxide doped with at least one selected from chrome, zirconium, and titanium; and an olivine-based oxide.

13. A cathode comprising:
the cathode material of claim 1; and
a current collector.

14. The cathode of claim 13, wherein the amount of solid of the cathode material is about 65 wt % or higher based on the total weight of the cathode.

15. The cathode of claim 14, wherein a bonding strength between the cathode material and the current collector is about 1.5 gf/mm or greater.

16. The cathode of claim 13, wherein a specific resistance of the cathode is 12 milliohms (mΩ) or lower.

17. A lithium battery comprising:
a cathode comprising the cathode material of claim 1;
an anode comprising an anode active material; and
an electrolyte between the cathode and the anode.

18. The lithium battery of claim 17, wherein the anode active material comprises at least one selected from a material capable of reversibly intercalating and deintercalating lithium ions, a lithium metal, and a metal material alloyable with lithium.

19. The lithium battery of claim 17, wherein the lithium battery is configured to be operated at a current density in a range of about 2 mA/cm² to about 8 mA/cm².

20. The lithium battery of claim 17, wherein the lithium battery is configured to power an electrical vehicle (EV) or a plug-in hybrid electric vehicle (PHEV).
